(19) United States
(12) Patent Application Publication
(10) Pub. No.: US 2010/0211533 A1
(43) Pub. Date: Aug. 19, 2010

(54) EXTRACTING STRUCTURED DATA FROM WEB FORUMS

(75) Inventors: Jiangming Yang, Beijing (CN); Rui Cai, Beijing (CN); Lei Zhang, Beijing (CN); Wei-Ying Ma, Beijing (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/388,517

(22) Filed: Feb. 18, 2009

(51) Int. Cl. G06F 15/18; G06N 5/02

(52) U.S. Cl. 706/12; 706/52

(57) ABSTRACT

The web forum data extraction technique is designed for the structured data extraction of data on web forums using both page-level information and site-level knowledge. To do this, the technique finds the kinds of page objects a forum site has, which object a page belongs to, and how different page objects are connected with each other. This information can be obtained by re-constructing the sitemap of the target forum which is based on a Data Object Model of the target forum. The web forum data extraction technique collects three kinds of evidence for data extraction: 1) inner-page features which cover both semantic and layout information on an individual page; 2) inter-vertex features which describe linkage-related observations; and 3) inner-vertex features which characterize interrelationships among pages in one vertex. The technique employs Markov Logic Networks to combine the types of evidence statistically for inference and thereby can extract the desired structures.

The rapid growth of the World Wide Web is making web forums (also called bulletin or discussion boards) an important data resource on the Web. With millions of users' contributions, plenty of highly valuable information has been accumulated on various topics. As a result, recent years have witnessed increased research efforts trying to leverage information extracted from forum data to build various web applications.

For most web applications, the fundamental step is to fetch data pages from various web sites distributed on the Internet via web crawling and to extract structured data from unstructured pages. Extracting structured data from unstructured forum pages represented in Hypertext Markup Language (HTML) format is done by removing useless HTML tags and noisy content like advertisements. Structured data on web forum sites includes data such as, for example, post title, post author, post time, and post content. However, automatically extracting structured data is not a trivial task due to both complex page layout designs and unrestricted user created posts. This has become a major hindrance for efficiently using web forum data. For web forums, different forum sites usually employ different templates.

In general, web data extraction approaches can be classified into two categories: template-dependent and template-independent. Template-dependent methods, just as the name implies, try to utilize a wrapper as an extractor for a set of web pages which are generated based on the same layout template. Template-independent methods usually treat data extraction as a segmentation problem and employ probabilistic models to integrate more semantic features and sophisticated human knowledge.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The web forum data extraction technique described herein is a template-independent approach specifically designed for structured data extraction of data on web forums. To provide a more robust and accurate extraction performance, the technique incorporates both page-level information and site-level knowledge. To do this, in one embodiment, the technique finds the kinds of page objects a forum site has, which object a page belongs to, and how different page objects are connected with each other. This information can be obtained by re-constructing the sitemap of the target forum. A sitemap is a directed graph in which each vertex represents one page object and each arc denotes a linkage between two vertices. The technique can identify vertices of list, post, and user profile from most forum sitemaps automatically. In one embodiment of the technique, the web forum data extraction technique collects three kinds of evidence for data extraction: 1) inner-page features which cover both semantic and layout information on an individual page; 2) inter-vertex features which describe linkage-related observations; and 3) inner-vertex features which characterize interrelationships among pages in one vertex. Finally, the technique employs Markov Logic Networks (MLNs) to combine all of these types of evidence (e.g., features) statistically for inference. By integrating all of the kinds of evidence and learning their importance, MLNs can handle uncertainty and tolerate imperfect and contradictory knowledge in order to extract desired data.

In the following description of embodiments of the disclosure, reference is made to the accompanying drawings which form a part hereof, and in which are shown, by way of illustration, specific embodiments in which the technique may be practiced. It is understood that other embodiments may be utilized and structural changes may be made without departing from the scope of the disclosure.

### DESCRIPTION OF THE DRAWINGS

The specific features, aspects, and advantages of the disclosure will become better understood with regard to the following description, appended claims, and accompanying drawings where:

FIG. 1 is an illustration of an exemplary forum sitemap and associated tree structure.

FIG. 2 is a schematic of an overview of the components of one embodiment of the web forum data extraction technique.

FIG. 3 provides an exemplary illustration of the relationships between list title and list record data structures employed in one embodiment of the web forum data extraction technique. Each number in parentheses denotes the corresponding equation number described in the specification.

FIG. 4 provides an exemplary illustration of the formulas of a post page, for extracting a post record and author in one embodiment of the web forum data extraction technique. Each number in parentheses denotes the corresponding equation number described in the specification.

FIG. 5 provides an illustration of the formulas of a post page, for extracting a post time and post content in one embodiment of the web forum data extraction technique. Each number in parentheses denotes the corresponding equation number described in the specification.

FIG. 6 is a flow diagram depicting an exemplary embodiment of a process for employing one embodiment of the web forum data extraction technique.

FIG. 7 is flow diagram depicting another exemplary embodiment of a process for employing the web forum data extraction technique.

FIG. 8 is an exemplary system architecture in which one embodiment of the web forum data extraction technique can be practiced.

FIG. 9 is a schematic of an exemplary computing device which can be used to practice the web forum data extraction technique.

### DETAILED DESCRIPTION

In the following description of the web forum data extraction technique, reference is made to the accompanying drawings, which form a part thereof, and which show by way of illustration examples by which the web forum data extraction technique described herein may be practiced. It is to be understood that other embodiments may be utilized and structural changes may be made without departing from the scope of the claimed subject matter.

1.0 Web Forum Data Extraction Technique.

In the following sections, some background information on web data extraction, the operating environment, and definitions of terms for the web forum data extraction technique is provided. Additionally, an overview of the technique is followed by details and exemplary embodiments.

1.1 Background

In general, web data extraction approaches can be classified into two categories: template-dependent and template-independent. Template-dependent methods, just as the name implies, try to utilize a wrapper as an extractor for a set of web pages which are generated based on the same layout template. Template-independent methods usually treat data extraction as a segmentation problem and employ probabilistic models to integrate more semantic features and sophisticated human knowledge. More specifically, a wrapper is usually represented in the form of regular expression or tree structure. Such a wrapper can be manually constructed, semi-automatically generated by interactive learning, or even discovered fully automatically. Most of web data extraction approaches utilize structure information of the Document Object Model (DOM) tree structure of a typical HTML page. However, for web forums, different forum sites usually employ different templates or wrappers. Even forums built with the same forum software have various customized templates. Additionally, most forum sites periodically update their templates for data extraction to provide an improved user experience. Therefore, the cost of both generating and maintaining wrappers for so many (maybe tens of thousands of) forum templates is extremely high and makes it impractical in real applications. Furthermore, wrapper-based methods also suffer from noisy and unrestricted data in forums.

To provide a more general solution for web data extraction, template-independent methods have been proposed. These approaches generally treat data extraction as a segmentation problem, and employ probabilistic models to integrate more semantic features and sophisticated human knowledge. Therefore, template-independent methods have little dependence on specific templates. In practice, existing template-independent methods of data extraction depend on features inside an individual page of a website, and separately infer each input page for extraction. For most applications, the page-level information is sufficient and the single page-based inference is also practical. However, for forum data extraction only adapting page-level information is not enough to deal with both complex layout designs and unrestricted user created posts in Web forums.

1.2 Operating Environment and Definitions

To facilitate the following discussions, the operating environment of web forum sites and associated definitions are briefly explained.

In forum data extraction, one usually needs to extract information from several kinds of pages such as list pages and post pages, each of which may correspond to one kind of data object. Pages of different objects are linked with each other. For most forums, such linkages are usually statistically stable, which can support some basic assumptions and provide additional types of evidence for data extraction. For example, if a link points to a page of user profile, the anchor of this link is very likely an author name. Secondly, the interrelationships among pages belonging to the same object can help verify the misleading information existing in some of individual pages. For example, although user-submitted HTML codes on some post pages may bring ambiguities in data extraction, a joint inference cross multiple post pages can help an extractor distinguish such noise. The linkages and interrelationships, both of which are dependent on site-structure information beyond a single page, are called site-level knowledge herein.

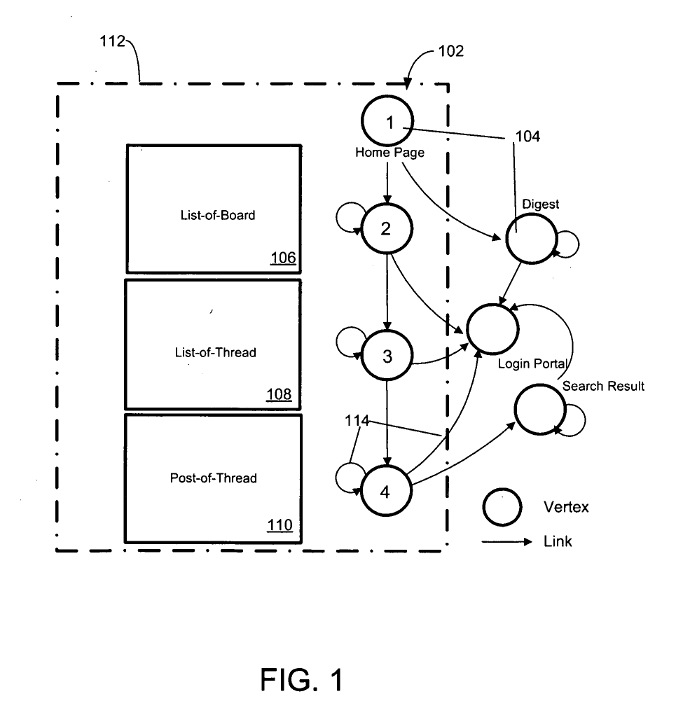

1.2.1 Sitemap. A sitemap is a directed graph consisting of a set of vertices and the corresponding links. Each vertex represents a group of forum pages which have similar page layout structure; and each link denotes a kind of linkage relationship between two vertices. FIG. 1 provides an exemplary illustration of the sitemap 102 for an exemplary forum. For vertices 104, one can find that each vertex is related to one kind of page in the forum, as shown in FIG. 1, with typical pages and labels. In one exemplary embodiment, the technique extracts information from the vertices, such as \list-of-board″ 106, \list-of-thread″ 108, and \post-of-thread″ 110, which are related to user-created content and marked within the dashed rectangle 112 in FIG. 1. Such information is very general as most forums have these vertices and the linkages 114 among these vertices are also stable. The vertices outside of the rectangle usually provide supportive functions for a forum.

1.2.2 List Page. For users' convenience, a well-organized forum site consists of a tree-like directory structure containing topics (commonly called threads) at the lowest end and posts inside threads. For example, the tree of the exemplary forum is a four-level structure shown in the dashed rectangle in FIG. 1. Pages from branch nodes on the tree are called list pages, such as the \list-of-board″ 106 and \list-of-thread″ 108 in FIG. 1. List pages within the same node share the same template and each page contains sets of list records. The corresponding post title in the list record will help users navigate to pages in its children nodes on the tree. Therefore, a goal of data extraction on such list pages is to extract the post title of every list record.

1.2.3 Post Page. Pages in the leaf node on the tree are called post pages 110, which contain detailed information of user posts. Each post usually consists of fields such as post author, post time, and post content, which are the goal of data extraction.

1.2.4 Exemplary Forum Data Extraction Definition. One can formally define the problem of web forum data extraction for one exemplary embodiment of the web forum data extraction technique as:
Definition 1. Given a Document Object Model (DOM) tree, data record extraction is the task of locating the minimum set of HTML elements that contains the content of a data record and assigning the corresponding labels to the parent node of these HTML elements. For a list page or post page containing multiple records, all of the data records should be identified.

1.3 Overview

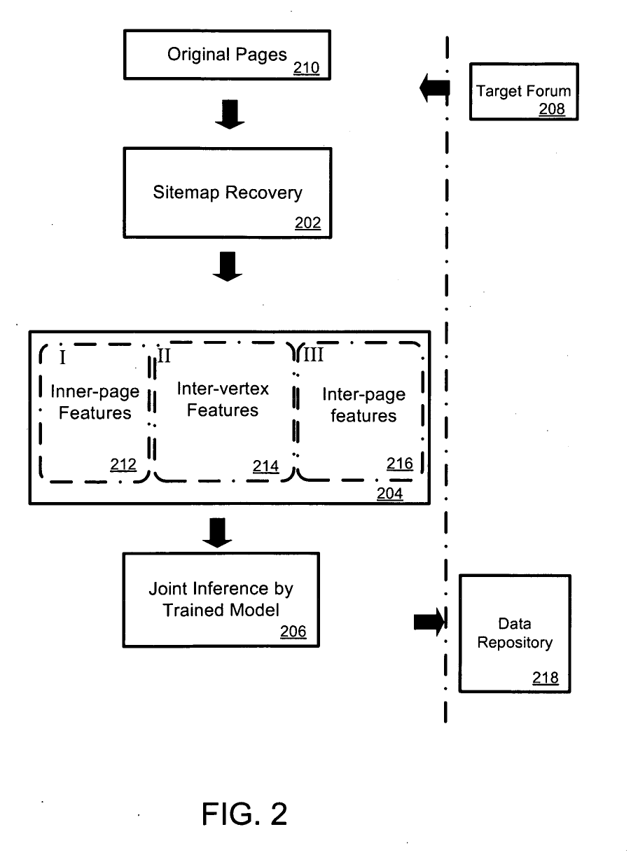

One high level exemplary schematic of the web forum data extraction technique is illustrated in FIG. 2, which mainly consists of three parts: (a) online sitemap recovery (block 202); b) feature extraction (block 204); and (c) joint inference by a trained inference model (e.g., for the pages with the same template) (block 206). These three parts will be explained in more detail in the following paragraphs.

7 In one embodiment of the technique, the goal of the first block 202 is to automatically estimate the sitemap structure of a target forum site 208 (e.g., one for which data is sought-to be extracted) using a few sampled pages 210. In practice, it was found that sampling around 2000 pages is enough to re-construct the sitemap of most forum sites. Pages with similar layout structures are further clustered into groups (vertices). Then, all possible links among various vertices are established if in the source vertex there is a page having an out-link pointing to a page in the target vertex. (For purposes of explanation, for a given link, the page which contains this link is called the source page. The page which the link navigates to is called the target page. The vertex which the source page belongs to is called the source vertex and the vertex which the target page belong to is called the target vertex._Each link is described by both a Uniform Resource Locator (URL) pattern and a location (the region where the corresponding out-links located). For example, the URL may consists of several tokens. Some different URLs may share some similar tokens. These tokens are called the URL pattern. One can use these pattern to describe the relations among these URLs. Finally, since some long lists or long threads may be divided into several individual pages connected by page-flipping links, the web forum data extraction technique can archive them together by detecting the page-flipping links and treating all entries on pages connected by page-flipping links as a single page. (Generally, a page-flipping link is a link that links continuing pages of a website). This greatly facilitates the following data extraction.

The second block depicts the feature extraction that takes place (block 204). In one embodiment of the technique, there are three kinds of features according to their generation source: (1) Inner-page features which leverage the relations among the elements inside a page, such as the size and location of each elements, an alignment relation, the inclusion relation among elements and the sequence order of elements; (2) Inter-template features which are generated based on the above site-level knowledge. Links with similar functions usually navigate to the same vertex on the sitemap, such as the list title which usually navigates to the vertex containing post pages. The web forum data extraction technique can get the function for each link based on its location. This is a very helpful feature to tag the correct labels to the corresponding elements; and (3) Inter-page features. For pages in a given vertex, records with same semantic labels (title, author, and etc.) should be presented in the same location in these pages. The web forum data extraction technique employs such features to improve the feature extraction results of pages in the same vertex.

Once the above-described features are obtained, in one embodiment, to combine these features effectively, the technique utilizes a Markov Logic Networks (MLNs) to model the aforementioned relation data. The web forum data extraction technique uses a joint inference model 206 to predict the location of the desired data structures (e.g., post title, post author, post time and post content). Markov logic networks provide a general probabilistic model for modeling relational data. MLNs have been applied to joint inference under different scenarios, such as segmentation of citation records and entity resolution. By the joint inference of pages inside one same vertex, the web forum data extraction technique can integrate all the three feature types and compute a maximum a posteriori (MAP) probability of all query evidences. This probability can be used to extract the desired data and optionally store it in a database 218.

1.4 Details and Exemplary Embodiments

An overview of the technique having been provided, in this section, the details of the above-described steps of various embodiments of the web forum data extraction technique are described. The details include information on Markov Logic Networks (MLNs), as well as the specifics of the features used in extracting data.

1.4.1 Markov Logic Networks-Mathematical Description

In one embodiment of the web forum data extraction technique, such as for example as shown in FIG. 2, block 206, the technique employs Markov Logic Networks (MLNs) to predict the location of data structures using a trained model. MLNs are a probabilistic extension of a first-order logic for modeling relation data. In MLNs, each formula has an associated weight to show how strong a constraint is: the higher the weight is, the greater the difference in log probability between a world that satisfies the formula and one that does not, other things being equal. In this sense, MLNs soften the constraints of a first-order logic. That is, when a world violates one constraint it is less probable, but not impossible. In a first-order logic, if a world violates one constraint it will have probability zero. Thus, MLNs provide a more sound framework for web forum data extraction since the real world is full of uncertainty, noise, and imperfect and contradictory knowledge.

A MLN can be viewed as a template for constructing Markov Random Fields. With a set of formulas and constants, MLNs define a Markov network with one node per ground atom and one feature per ground formula. The probability of a state x in such a network is given by

$$P ( X = x ) = \frac{1}{Z} {\prod }_{i} {{φ}_{i} ( {x}_{\{ i \}} )}^{{n}_{i} ( x )} \qquad ( 1 )$$

where Z is a normalization constant, nᵢ(x) is the number of true groundings of Fᵢ in x,x₍ᵢ₎ is the state (truth values) of the atoms appearing in Fᵢ and φᵢ(x₍ᵢ₎=e^{w}^{ᵢ}), wᵢ is the weight of the i^{th} formula.

Eq. (1) defines a generative MLN model, that is, it defines the joint probability of all the predicates. In one embodiment of the web forum data extraction technique for forum page segmentation, the evidence predicates and the query predicates are known a prior. Thus, the technique turns to employing a discriminative MLN. Discriminative models have the great advantage of incorporating arbitrary useful features and have shown great promise as compared to generative models. The web forum data extraction technique partitions the predicates into two sets the evidence predicates X and the query predicates Q. Given an instance x, the discriminative MLN defines a conditional distribution as follows:

$$P ( q \vert x ) = \frac{1}{{Z}_{x} ( w )} exp {\sum }_{i ∈ {F}_{Q}} {\sum }_{j ∈ {G}_{i}} {w}_{i} {g}_{j} ( q , x ) \qquad ( 2 )$$

where F_{Q} is the set of formulas with at least one grounding involving a query predicate, Gᵢ is the set of ground formulas of the i^{th} first-order formula, and Zₓ(w) is the normalization factor. gⱼ(q,x) is binary and equals to 1 if the jth ground formula is true and 0 otherwise.

With the conditional distribution in Eq. (2), web data extraction is a task to compute maximum a posteriori (MAP) probability of query predicate q and extract data from this assignment q*:

$${q}^{*} = arg \frac{max}{q} P ( q \vert x ) \qquad ( 3 )$$

In one embodiment of the web forum data extraction technique, the technique mainly focuses on extracting the following six objects, list record, list title, post record, post author, post time, and post content. The atomic extraction units are HTML elements. Thus, in the MLN model, the technique defines the corresponding query predicates q as, IsListRecord(i), IsTitleNode(i), IsPostRecord(i), IsAuthorNode(i), IsTimeNode(i), and IsContentNode(i), respectively, where i denotes the ith element. The evidence x are the features of the HTML elements. In a discriminative MLN model as defined in Eq. (2), the evidence x can be arbitrary useful features. In one embodiment of the technique, the features include three types: inner-page features (e.g., the size and location of each element), inter-template features (e.g., the alignment relation among elements) and inter-page features (e.g., the order among some time-like elements). With these predefined features, the technique in one embodiment employs rules or the formulas in MLNs, (e.g., such as the post record element must contain post author, post time and post content nodes, among others) to define inter-relationships between objects. These formulas represent relationships among HTML elements. With these formulas, the resultant MLN can effectively capture the mutual dependencies among different extractions and thus achieve a globally consistent joint inference.

Note that in the above general definition, the technique can treat all of the HTML elements identically when formulating the query and evidence predicates. However, in practice, HTML elements can show obviously different and non-overlapping properties. For example, the elements staying at the leaves of a DOM tree are quite different from the inner nodes. Only the elements at leaf nodes can be a post author or a post time; only the inner elements can be list record or a post record. Thus, the technique can group these elements into three non-overlapping groups, as will be discussed in more detail later. This can be implemented in an MLN model by defining them as different types. In this way, the web forum data extraction technique can significantly reduce the number of possible groundings when MLN is performing inference. Also, this prior grouping knowledge can reduce the ambiguity in the model and thus achieve better performance.

1.4.2 Features

The following paragraphs describe the categories of features and a description of the types of features (inner-page, inter-vertex and inner-vertex) used in training a joint inference model and using it to identify desired data employed in one embodiment of the web forum data extraction technique.

1.4.2.1 Categories of Features

To accelerate the training and inference process, the DOM tree elements are divided into the following three categories according to their attributes. These include text elements, hyperlink elements and inner elements.

(a) Text element (t). Text elements always acts as leaves in DOM trees and ultimately contain all of the extracted information. For some plain text information like post time, the technique identifies this kind of element in data extraction.

(b) Hyperlink element (h). Hyperlink elements correspond to hyperlinks in a web page which usually have tags (e.g., <a>) in HTML files. Web pages inside a forum are connected to each other through hyperlinks. For example, list pages and post pages are linked together by hyperlinks of post titles pointing from the former to the latter. Inside a forum site, some desired information such as, for example, post title and post author, is always enveloped in hyperlink elements.

(c) Inner element (i). All the other elements besides text elements and hyperlink elements located inside a DOM tree are defined as inner elements or inner nodes. In practice, the list records or post records and post contents are always embraced in inner elements.

In one embodiment, the MLN model, the web forum data extraction technique treats the above three kinds of evidence (text, hyperlink and inner element) separately to accelerate the training and inference process. In the following paragraphs, the above three kinds of evidence will be represented as t, h, and i, respectively. The corresponding features are listed in Table 1.

TABLE 1
Feature Descriptions

| Type | Feature | Description |
|---|---|---|
| Inner-Page | IsTimeFormat(t) | The text string in text node t appears as time-format. |
| | ContainTimeNode(i) | There exist one text element t, t is contained in inner node i |
| | | and IsTimeFormat(t) is true. |
| | HasLongestLink(i; h) | The hyperlink node h is embraced in the inner node i and |
| | | its text content is longer than any other hyperlink embraced |
| | | in i. |
| | HasDescendant(i; i′) | The inner node i′ is one of the descendants of the inner |
| | | node i. |
| | ContainLongText(i) | The inner node i has several text elements in its sub DOM |
| | | tree which contain long periods of text contents. |
| | InnerAlign(i; i′) | The location of inner node i and its sub DOM tree structure |
| | | are similar with those of another inner node i′ |
| | HyperAlign(h; h′) | The location of hyperlink node h and its sub DOM tree |
| | | structure are similar with those of another hyperlink node |
| | | h′. |
| | TextAlign(t; t0) | The location of text node t and its sub DOM tree structure |
| | | are similar with those of another text node t0. |
| | IsRepeatNode(i) | There is at least one sibling of the inner node i which has a |
| | | similar sub DOM tree. |
| | UnderSameOrder(t) | The IsTimeFormat(t) is true and follows the ascendent or |
| | | descendant order with all other time contents in the same |
| | | location. |
| Inter- | IsPostLink(h) | The hyperlink node h navigates to post-of-thread vertex. |
| vertex | HasPostLink(i; h) | The hyperlink node h is embraced in the inner node i and |
| | | IsPostLink(h) is true. |
| | ContainPostlink(i) | There exists one hyperlink element h which is contained in |
| | | the inner node i and IsPostLink(h) is true. |
| | IsAuthorLink(h) | The hyperlink node h navigates to the author profile vertex. |
| | HasAuthorLink(i; h) | The hyperlink node h is embraced in the inner node i and |
| | | IsAuthorLink(h) is true |
| | ContainAuthorLink(i) | There exist one hyperlink element h which is contained |
| | | in the inner node i and IsAuthorLink(h) is true. |
| Inner- | InnerAlignIV (i; i′) | The inner node i in one page shares similar DOM path and |
| Vertex | | tag attributes along the path with another inner node i′ in |
| | | another page. |
| | HyperAlignIV (h; h′) | The hyperlink node h in one page shares similar DOM path |
| | | and tag attributes along the path with another hyperlink |
| | | node h′ in another page. |
| | TextAlignIV (t; t0) | The text nodes t in one page shares similar DOM path and |
| | | tag attributes along the path with another text not t′ on |
| | | another page |

1.4.2.2 Inner-Page Features

Inner-page features leverage the relations among elements inside a page; and are listed in Table 1. These features correspond to block 212 of block 204 in FIG. 2 and can be described from four aspects: a time feature, an inclusion relation, an alignment relation and a time order. These are described in more detail below.
(a) The time feature: To extract time information, in one embodiment, the technique gets candidates whose content is short and contain a string like mm-dd-yyyy, dd/mm/yyyy, or some specific terms like Monday and January. This evidence can be presented as IsTimeFormat(t) for each text element t. Similarly, one can introduce another evidence ContainTimeNode(i).
(b) The inclusion relation: Data records usually have inclusion relations. For example, a list record should contain a list title which can be represented as HasLongestLink(i, h); a post content should be contained in a post record and usually contains a large ratio of text which can be represented as HasDescendant(i,i′) and ContainLongText(i).
(c) The alignment relation: Since data is generated from a database and represented via templates, data records with the same label may appear repeatedly on a page. If the technique can identify some records with high confidence, it may assume other records aligned with these records should have the same label. One embodiment of the web forum data extraction technique employs two methods to generate the alignment information: (1) By rendering via a web browser, the technique can get the location information of each element. Two elements are aligned with each other if they are aligned similarly in the vertical or horizontal direction; and (2) By recursively matching their children nodes pair by pair, the technique can define a similarity measurement including the comparison of nodes' tag types, tag attributes, and even contained text blocks. One can represent the alignment relation similarity on i, h, and t as InnerAlign(i, i′), HyperAlign(h, h′), and TextAlign(t, t′). One can get the similar alignment relation if an element is aligned with its sibling nodes and represent it as IsRepeatNode(i).
(d) Time Order: The order of the post time is quite special. Since post records are generated sequentially along a time-line, the post time should be sorted ascendently or descendantly. This helps to distinguish other noisy time content such as users' registeration time, to obtain the right information. If the time information in the same location satisfies the ascendent or descendant order, the technique represents it as UnderSameOrder(t).

1.4.2.3 Inter-Vertex Features

The inter-vertex features are generated based on site-level knowledge. In a sitemap, the pages inside a given vertex usually have similar functions, as shown in FIG. 1. If the technique can navigate to a vertex that contains post pages via a given link in a list page, this link probably represents the title of a thread. In one embodiment of the web forum data extraction technique, this is represented as IsPostLink(h), HasPostLink(i, h), and ContainPostlink(i). Similarly, if the technique can navigate to a vertex that contains profile pages via a given link, this link probably contains a user name. One embodiment of the technique represents this as IsAuthorLink(h), HasAuthorLink(i, h), and ContainAuthorlink(i). For each given page, the technique can map it to one vertex and get the function of each link in this page based on the location of this link. These features are also listed in Table 1 and correspond to block 214 of block 204 in FIG. 2.

1.4.2.4 Inner-Vertex Features

In general, for different pages of the same vertex in the sitemap of a forum, the records of the same semantic labels (title, author and etc.) should be presented in the same DOM path. In one embodiment, the technique employs these alignment features to further improve the results within a set of pages belonging to the same template. These features can be leveraged for the three kinds of elements i, h, and t, respectively. These can be represented as InnerAlignIV(i,i′), HyperAlignIV(h,h′), and TextAlignlV(t,t′). These features are also listed in Table 1 and correspond to block 216 of block 204 in FIG. 2.

1.4.3 Formulas

In this section, the detailed formulas used in the two models of list pages and post pages, respectively, of one embodiment of the technique, are described in more detail.

1.4.3.1 Formulas of List Page

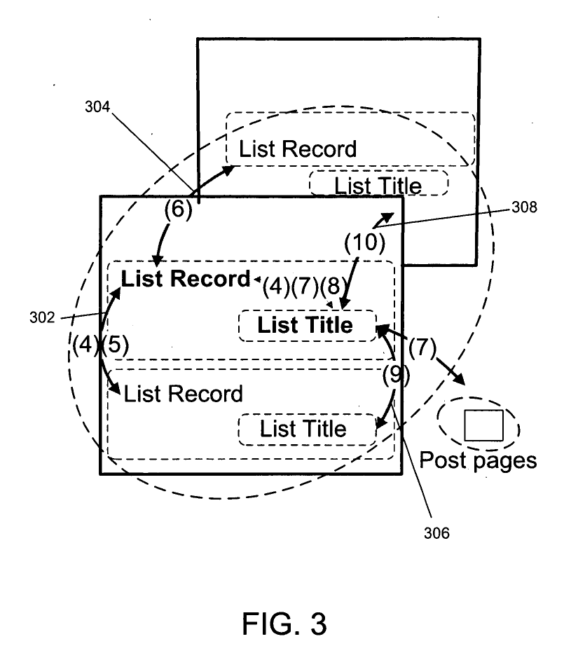

In one embodiment of the web forum data extraction technique, it is assumed that list records should be inner nodes and list titles should be contained in hyperlink nodes. In order to extract them accurately, one embodiment of the technique introduces some rules which are presented as the following formulas. There are two kinds of rules which basically present the relations among the queries and the evidences. The relations for list record and list title are shown in FIG. 3. The numbers in parenthesis correspond to the equation numbers indicated below.

(1) Formulas for identifying list record. A list record usually contains a link of list title which also appears repeatedly. One can identify list record if a candidate element is aligned with a known list record inside a page 302 or aligned with a known list record in another page 304 of the same vertex. This is shown in FIG. 3:

∀i, ContainPostLink(i) [symbol] IsRepeatNode(i) [symbol] IsListRecord(i) (4)

∀i, i′, IsListRecord(i) [symbol] InnerAlign(i, i′) [symbol] IsListRecord(i′) (5)

∀i, i′, IsListRecord(i) [symbol] InnerAlignIV(i, i′) [symbol] IsListRecord(i′) (6)

(2) Formulas for identifying list title. A list title usually contains a link to a vertex of post pages and is contained in list record. Equation (8) is useful when site level information is not available. It is also possible to identify list title if a candidate element is aligned with a known list title inside a page 306 or aligned with a known list title in another page 308 of the same vertex. This is also shown in FIG. 3.

∀i, h, IsListRecord(i) [symbol] HasPostLink(i, h) [symbol] IsTitleNode(h) (7)

∀i, h, IsListRecord(i) [symbol] HasLongestLink(i, h) [symbol] IsTitleNode(h) (8)

∀i, h′, IsTitleNode(h) [symbol] A HyperAlign(h, h′) [symbol] IsTitleNode(h′) (9)

∀i, h′, IsTitleNode(h) [symbol] HyperAlignIV(h, h′) [symbol] IsTitleNode(h′) (10)

1.4.3.2 Formulas of Post Page

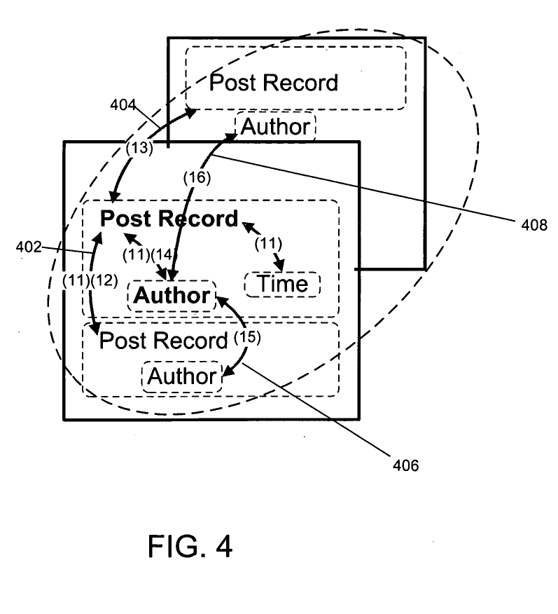

A post record and post content should be contained in inner nodes, while a post author should be contained in hyperlink nodes and post time always appears in a text node as time-format. One embodiment of the technique can identify, the desired information by inferring these predicates and using some established rules to describe the required elements according to their own evidences. The relations among post record, post author, post time, and post content respectively are also drawn in the FIG. 4.

(1) Formulas for identifying Post record. A post record usually contains a link for post author and post time and appears repeatedly. The technique will also identify post record if a candidate element is aligned with a known post record inside a page 402 or is aligned with a known post record in another page 404 of the same vertex. This shown in FIG. 4.

∀i, ContainAuthor Link(i) [symbol] ContainTimeNode(i) [symbol] IsRepeatNode(i) [symbol] IsPostRecord(i) (11)

∀i, i′,IsPostRecord(i) [symbol] InnerAlign(i, i′) [symbol] IsPostRecord(i′) (12)

∀i, i′, IsPostRecord(i) [symbol] InterInnerAlign(i, i′) [symbol] IsPostRecord(i′) (13)

(2) Formulas for identifying post author. A post author usually contains a link to the vertex of profile pages and is contained in a post record. The technique identifies a post author if a candidate element is aligned with a known post author inside a page 406 or is aligned with a known post author in another page 408 of the same vertex. This is also shown in FIG. 4.

∀iIsPostRecord(i, h) [symbol] HasAuthorLink(i, h) [symbol] [symbol] IsAuthorNode(h) (14)

∀h, h′, IsAuthorNode(h) [symbol] HyperAlign(h, h′) [symbol] IsAuthorNode(h′) (15)

∀h,h′,IsAuthorNode(h) [symbol] HyperAlignlV(h, h′) [symbol] IsAuthorNode(h′) (16)

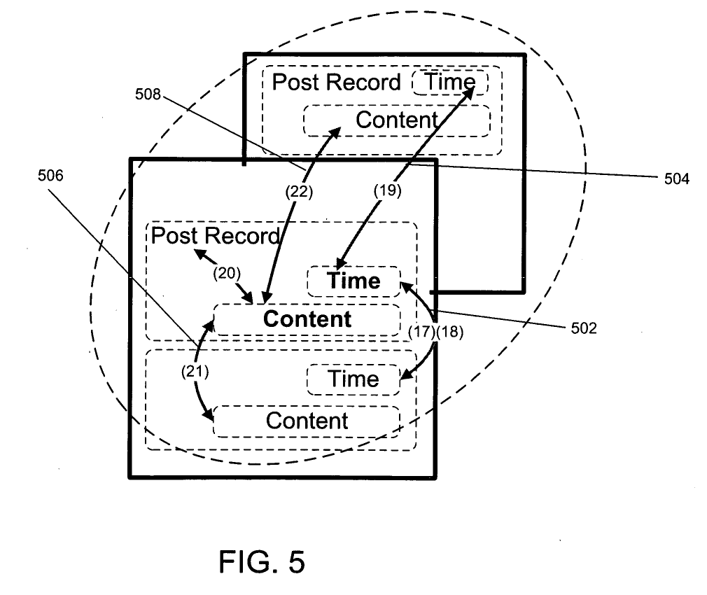

(3) Formulas for identifying Post time. A post time usually contains time-format content and is sorted ascendently or descendently. The technique will also identify post time if a candidate element is aligned with a known post time inside a page 502 or aligned with a known post time in another page 504 of the same vertex. This is shown in FIG. 5.

∀iUnderSameOrder(t) [symbol] IsTimeNode(t) (17)

∀t,t′IsTimeNode(t) [symbol] TextAlign(t,t′) [symbol] IsTimeNode(t′) (18)

∀t,t′IsTimeNode(t) [symbol] TextAlignIV(t,t′) [symbol] IsTimeNode(t′) (19)

(4) Formulas for identifying post content. Post content is usually the descendant of a post record and does not contain post time and post author. The technique identifies post content if a candidate element is aligned with a known post content inside a page 506 or aligned with known post content in another page 508 of the same vertex. This is also shown in FIG. 5.

∀i, i′, IsRepeatNode(i) [symbol] HasDescendant(i, i′) [symbol] A ContainLongText(i′) [symbol] [symbol] ContainTimeNode(i′) [symbol] [symbol] ContainHyperLinkAuthor(i′)) [symbol] IsContentNode(i′) (20)

∀i, i′, IsContentNode(i) [symbol] InnerAlign(i, i′) [symbol] IsContentNode(i′) (21)

∀i, i′, IsContentNode(i) [symbol] InnerAlignlV(i, i′) [symbol] IsContentNode(i′) (22)

The overview and details of various implementations of the web forum data extraction technique having been discussed, the next sections provide exemplary embodiments of processes and an architecture for employing the technique.

### 1.5 Exemplary Processes Employed by the Web Forum Data Extraction Technique.

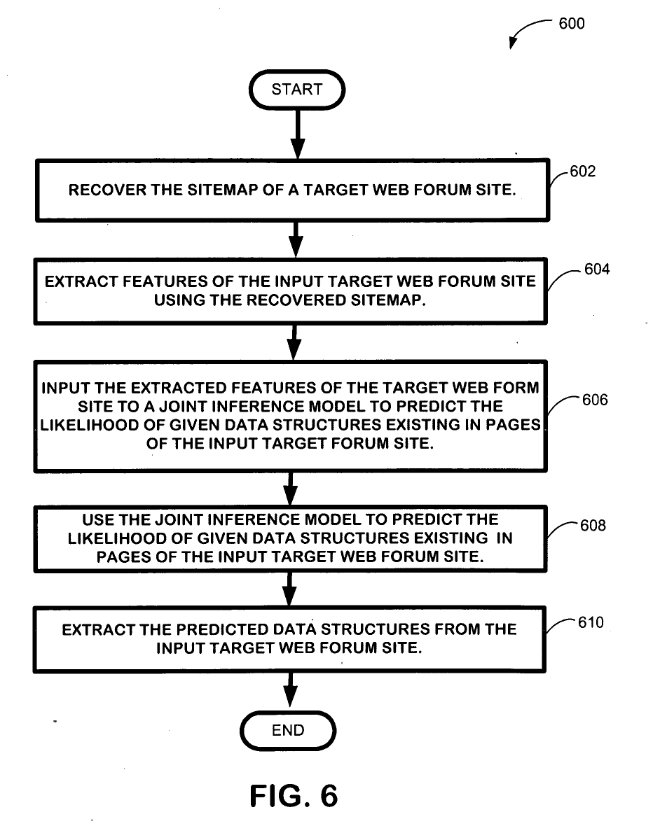

An exemplary process 600 employing the web forum data extraction technique is shown in FIG. 6. As shown in FIG. 6, block 602, a sitemap of a target web forum site is recovered. Features of the input target forum site are extracted using the recovered sitemap (block 604). The extracted features and sitemap of the target web forum site are input into a joint inference model to predict the likelihood of given data structures existing in pages of the input target forum site, as previously described and as shown in block 606. The joint inference model is then used to predict the likelihood of given data structures existing in pages of the input target web forum site, as shown in block 608. Finally, the predicted data structures are extracted from the input target web forum site, as shown in block 610, and can optionally be stored or used for various other applications.

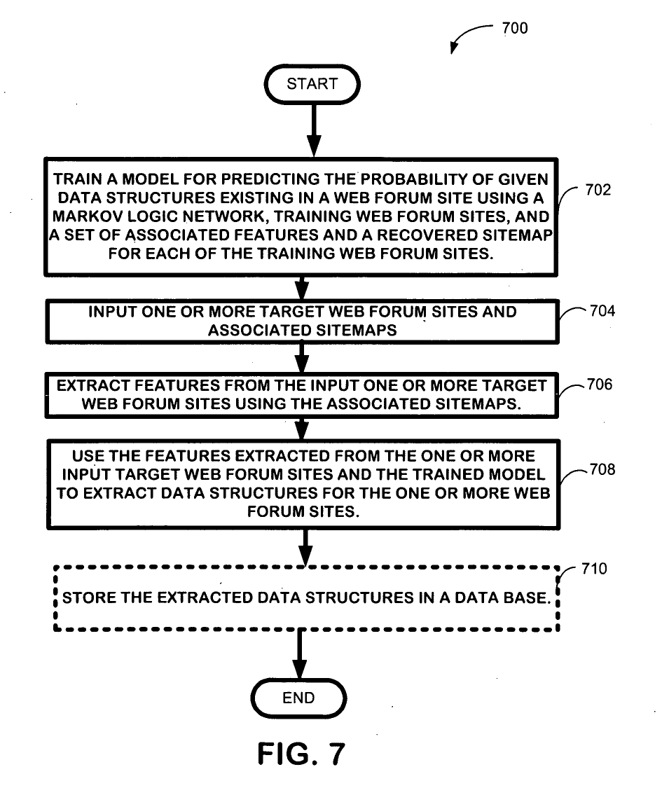

FIG. 7 depicts another exemplary process 700 employing one embodiment of the web forum data extraction technique. In this embodiment the model for predicting the probability of given data structures existing on a web forum site is first trained. More specifically, as shown in block 702, a model for predicting the probability of given data structures existing in a web forum is trained using a set of training sample web forum pages and an associated set of features, as well as a sitemap for each training web forum. One or more new target web forum sites are then input, as shown in block 704. Features of the one or more input target web forum sites are then extracted using the associated sitemaps, as shown in block 706. The trained model and the extracted features from the one or more input web forum sites are then used to extract data from the one or more input target web forum sites, as shown in block 708. The extracted data structures can then be optionally stored in a database if desired, as shown in block 710.

### 1.6 Exemplary Architecture Employing the Web Forum Data Extraction Technique.

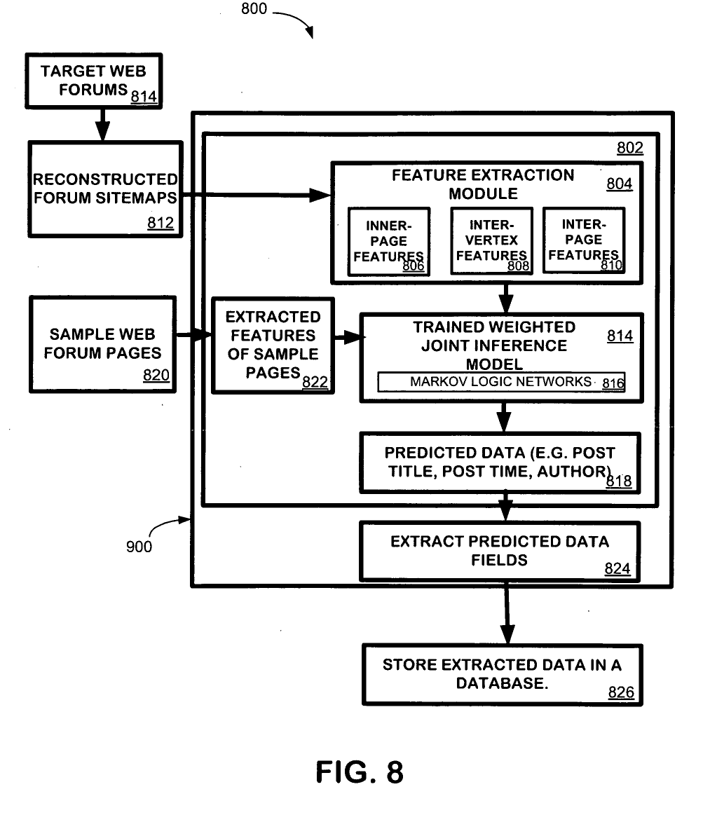

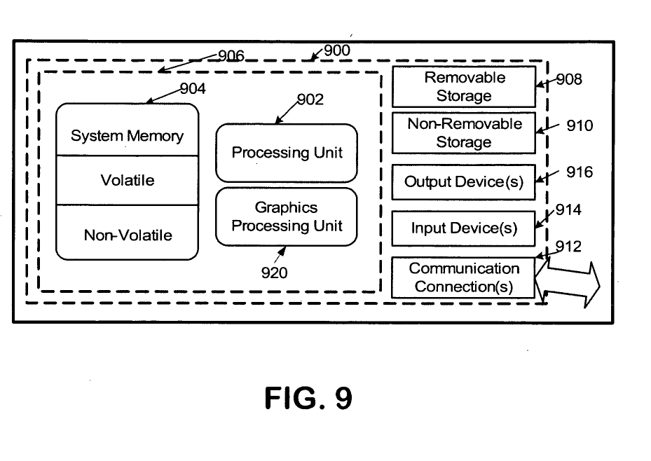

FIG. 8 provides one exemplary architecture 800 in which one embodiment of the web forum data extraction technique can be practiced. As shown in FIG. 8, block 802, the architecture 800 employs a data extraction module 802, which typically resides on a general computing device 900 such as will be discussed in greater detail with respect to FIG. 9. The data extraction module 802 has a feature extraction module 804 which identifies inner-page features 806, inter-vertex features 808 and inter-page features 810, respectively, based on a reconstructed forum sitemap 812 which is based on a given target web forum 814. The features 806, 808 and 810 and 812 are used by a trained weighted joint inference model 814 which in one embodiment uses Markov Logic Networks 816. The inference model 814 is used to predict the probability that predicted data structures 818 (e.g., list record, list title, post title, post time, post content, author) are on a target web forum. The joint inference model 814 is trained using a set of sample web forum pages 820 and associated extracted features of the sample pages 822. The predicted data 818 is used to extract the data structures from the web pages of the target forum 824. The extracted data can then optionally be stored in a database 826 or used in other manners.

### 2.0 The Computing Environment

The web forum data extraction technique is designed to operate in a computing environment. The following description is intended to provide a brief, general description of a suitable computing environment in which the web forum data extraction technique can be implemented. The technique is operational with numerous general purpose or special purpose computing system environments or configurations. Examples of well known computing systems, environments, and/or configurations that may be suitable include, but are not limited to, personal computers, server computers, hand-held or laptop devices (for example, media players, notebook computers, cellular phones, personal data assistants, voice recorders), multiprocessor systems, microprocessor-based systems, set top boxes, programmable consumer electronics, network PCs, minicomputers, mainframe computers, distributed computing environments that include any of the above systems or devices, and the like.

FIG. 9 illustrates an example of a suitable computing system environment. The computing system environment is only one example of a suitable computing environment and is not intended to suggest any limitation as to the scope of use or functionality of the present technique. Neither should the computing environment be interpreted as having any dependency or requirement relating to any one or combination of components illustrated in the exemplary operating environment. With reference to FIG. 9, an exemplary system for implementing the web forum data extraction technique includes a computing device, such as computing device 900. In its most basic configuration, computing device 900 typically includes at least one processing unit 902 and memory 904. Depending on the exact configuration and type of computing device, memory 904 may be volatile (such as RAM), non-volatile (such as ROM, flash memory, etc.) or some combination of the two. This most basic configuration is illustrated in FIG. 9 by dashed line 906. Additionally, device 900 may also have additional features/functionality. For example, device 900 may also include additional storage (removable and/or non-removable) including, but not limited to, magnetic or optical disks or tape. Such additional storage is illustrated in FIG. 9 by removable storage 908 and non-removable storage 910. Computer storage media includes volatile and nonvolatile, removable and non-removable media implemented in any method or technology for storage of information such as computer readable instructions, data structures, program modules or other data. Memory 904, removable storage 908 and non-removable storage 910 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 900. Any such computer storage media may be part of device 900.

Device 900 also contains communications connection(s) 912 that allow the device to communicate with other devices and networks. Communications connection(s) 912 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media. The term computer readable media as used herein includes both storage media and communication media.

Device 900 may have various input device(s) 914 such as a display, a keyboard, mouse, pen, camera, touch input device, and so on. Output device(s) 916 such as speakers, a printer, and so on may also be included. All of these devices are well known in the art and need not be discussed at length here.

The web forum data extraction technique may be described in the general context of computer-executable instructions, such as program modules, being executed by a computing device. Generally, program modules include routines, programs, objects, components, data structures, and so on, that perform particular tasks or implement particular abstract data types. The web forum data extraction technique may be practiced in distributed computing environments where tasks are performed by remote processing devices that are linked through a communications network. In a distributed computing environment, program modules may be located in both local and remote computer storage media including memory storage devices.

It should also be noted that any or all of the aforementioned alternate embodiments described herein may be used in any combination desired to form additional hybrid embodiments. Although the subject matter has been described in language specific to structural features and/or methodological acts, it is to be understood that the subject matter defined in the appended claims is not necessarily limited to the specific features or acts described above. The specific features and acts described above are disclosed as example forms of implementing the claims.

Wherefore, what is claimed is:

1. A computer-implemented process for extracting structured data from web forums, comprising:
training a model for predicting the probability of given data structures existing a web forum by using training web forum sites, and an associated set of features and a web forum sitemap for each of the training web forum sites;
inputting a set of one or more target web forum sites and associated target web forum sitemaps;
extracting features from the one or more input target web forum sites using the associated target web forum sitemaps; and
using the trained model and the extracted features from the one or more input web forum sites to extract data from the one or more input target web forum sites.

2. The computer-implemented process of claim 1, further using a Markov Logic Network to train the model.

3. The computer-implemented process of claim 1, further comprising using features comprising inner-page features that define the relationships between data elements on a web forum page.

4. The computer-implemented process of claim 1, further comprising using features comprising inter-vertex features that define a relationship between different types of page layouts on a web forum.

5. The computer-implemented process of claim 1, further comprising using features comprising inner-vertex features that define a relationship between pages with the same layout on a web forum.

6. The computer-implemented process of claim 1 further comprising using feature categories comprising:
text elements;
hyperlink elements; and
inner elements.

7. The computer-implemented process of claim 3 wherein the inner-page features further comprise:
time features;
an inclusion relation;
an alignment relation; and
time order.

8. The computer-implemented process of claim 4 wherein the inter-vertex features are based on the links between pages on a web forum site.

9. The computer-implemented process of claim 5 wherein the inner-vertex features use records of the same semantic labels as alignment features to extract features.

10. The computer-implemented process of claim 1, wherein the extracted data further comprises, post record, post author, post time and post content.

11. The computer-implemented process of claim 10, wherein the extracted data further comprises list record and list title.

12. A system for extracting data from web forums, comprising:
a general purpose computing device;
a computer program comprising program modules executable by the general purpose computing device, wherein the computing device is directed by the program modules of the computer program to,
input at least one web forum site for which data is to be extracted;
perform sitemap recovery to recover the web forum sitemap structure of the at least one web forum site;
perform feature extraction using the web forum sitemap structure to extract features from the at least one web forum site; and
input the extracted features into a joint inference model to obtain the location of the data to be extracted.

13. The system of claim 12 wherein the joint inference model employs Markov Logical Networks to determine the probability that the data to be extracted exists in any location in the at least one web forum site.

14. The system of claim 12 wherein the features further comprise:
inner-page features that define the relationships between data elements on a web forum page;
inter-vertex features that define the relationship between different types of page layouts on a web forum; and
inner-vertex features that define the relationship between pages with the same layout on a web forum.

15. A computer-implemented process for extracting data from web forums, comprising:
recovering the sitemap of a target web forum site;
extracting features of an input target web forum site using the recovered sitemap;
inputting the extracted features of the target web forum site to a joint inference model that employs Markov Logic Networks to predict the likelihood of given data structures existing in pages of the input target forum site;
using the joint inference model to predict the likelihood of given data structures existing in pages of the input target web forum site; and
extracting the predicted data structures from the input target web forum site.

16. The computer-implemented process of claim 15 wherein the extracted features further comprise:
inner-page features that define the relationships between data elements on a web forum page;
inter-vertex features that define the relationship between different types of page layouts on a web forum; and
inner-vertex features that define the relationship between pages with the same layout on a web forum.

17. The computer-implemented process of claim 16 wherein the inner-page features further comprise:
time features;
an inclusion relation;
an alignment relation; and
time order.

18. The computer-implemented process of claim 15 wherein using the joint inference model further comprises:
finding the kinds of page objects each input target web forum site has;
finding which object a input target web forum site page belongs to; and
finding how different page objects are connected with each other.

19. The computer-implemented process of claim 15, wherein the predicted data structures further comprise post record, post author, post time, post content, list record and list title.

20. The computer-implemented process of claim 15 wherein the the sitemap of a target web forum site is based on a Data Object Model tree and the features are categorized by text elements, hyperlink elements and inner elements.
